(19) United States
(12) Patent Application Publication
(10) Pub. No.: US 2012/0255851 A1
(43) Pub. Date: Oct. 11, 2012

(54) Combination Pressure and Temperature Sensor for Simultaneous Temperature and Pressure Analyzing in HVAC Ducts

(76) Inventor: Clark Donnell Freeman, Yorba Linda, CA (US)

(21) Appl. No.: 13/433,242

(22) Filed: Mar. 28, 2012

Related U.S. Application Data
(60) Provisional application No. 61/471,846, filed on Apr. 5, 2011.

(51) Int. Cl. H01H 35/34

(52) U.S. Cl. 200/83 A

(57) ABSTRACT

The present invention is a dual temperature and pressure switch that simultaneously monitors both the duct static pressure and temperature within HVAC ducts. The present invention comprises a differential pressure switch and a temperature probe. The differential pressure switch is triggered if the duct static pressure becomes greater than a prescribed level. A pressure switch diaphragm translates within the differential pressure housing according to the difference of static pressure and atmospheric pressure. The prescribed level is set by an adjustment screw and calibration spring. Each the static pressure probe and the temperature probe traverse through the sensor housing into an HVAC duct to which it is installed. Each the differential pressure switch and temperature probe are electrically connected to a control system through a terminal block. The present invention can include an analog pressure transmitter to analyze the current duct static pressure.

The current application claims a priority to the U.S. Provisional Patent application Ser. No. 61/471,846 filed on Apr. 5, 2011.

### FIELD OF THE INVENTION

The present invention relates generally to duct temperature sensor and air pressure switches in heating ventilation and air conditioning (HVAC) systems. More particularly, its objective is to combine a duct temperature sensor and an air pressure switch to simultaneously measure or monitor HVAC system duct temperature and confirming HVAC fan operation by a single device.

### BACKGROUND OF THE INVENTION

Micro-processor based, direct digital (DDC) HVAC control systems commonly monitor the HVAC supply duct air temperature as part of a control function or for maintenance purposes. It is also common for DDC systems to monitor the status of the HVAC unit supply fan to check that the fan is operating properly. The industry standard for monitoring duct air temperature is by means of an insertion-type duct temperature sensor with a resistive thermistor or a resistance temperature detector (RTD) inserted into the air duct. Determining if the fan is operating properly is typically obtained by monitoring the supply duct air static pressure by separately installed duct static pressure probe. The duct static pressure probe is typically connected to a separate differential pressure switch. Proper operation of the fan can also be determined by an electrical current switch that can analyze the fan motor current. The installation of a separate pressure switch or fan current switch and most similar related electrical control system conduit, wiring and/or tubing can add significant labor and material cost to a controls project. The static pressure switch requires a hole to be drilled into the air duct for the static pressure probe to be inserted through, whereas a fan current switch requires the installation of control conduit and/or wiring to be run the distance from a wall mounted DDC control panel or DDC thermostat to the remotely located HVAC unit.

The present invention allows air duct temperature and HVAC fan status to be monitored simultaneously through one device. By combining the two separate sensor devices into one unit, the present invention significantly streamlines the accomplishment of monitoring duct temperature and fan status in HVAC systems. Only the installation of a single conduit and related wiring from the present invention to the controller is required.

### BRIEF DESCRIPTION OF THE DRAWINGS

FIG. 1 is a schematic view of the present invention, showing its inner components and their corresponding connections.

FIG. 2 is a perspective view of the present invention, showing the present invention installed onto a duct.

### DETAIL DESCRIPTIONS OF THE INVENTION

All illustrations of the drawings are for the purpose of describing selected versions of the present invention and are not intended to limit the scope of the present invention.

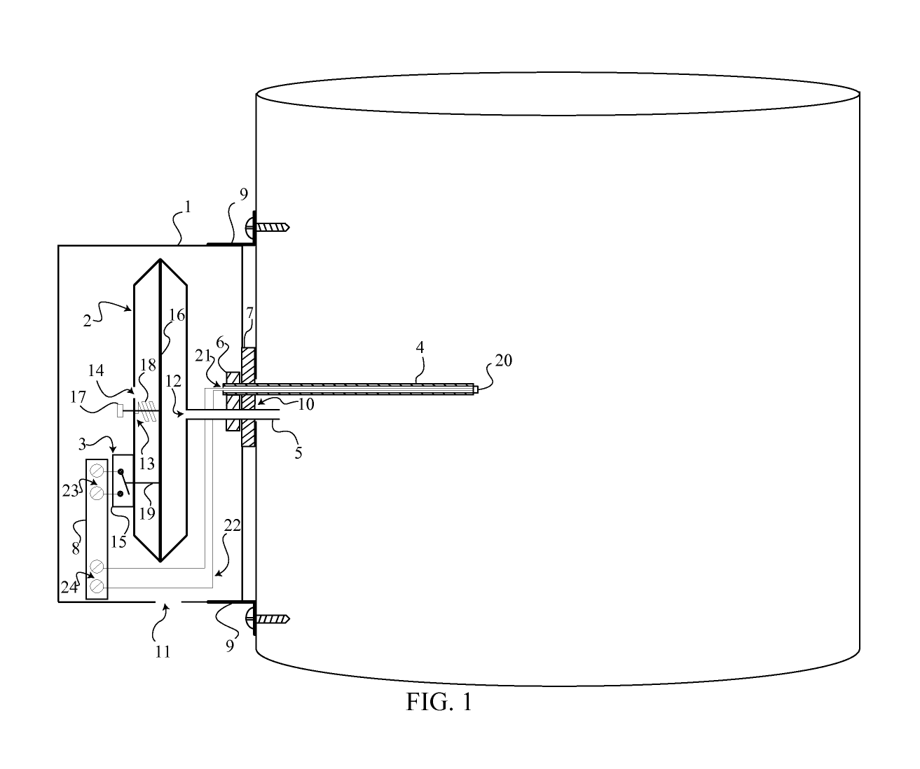

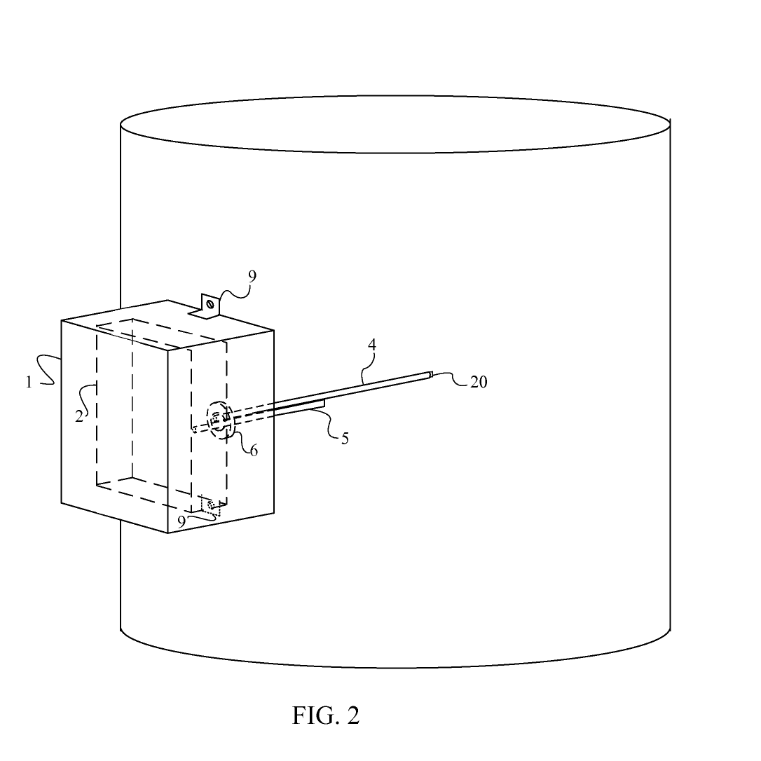

As can be seen from FIG. 1 and FIG. 2, the present invention is a dual pressure monitoring and temperature measuring device that should be used with HVAC ducts. The present invention comprises a sensor temperature probe 4 and a static pressure probe 5 to measure or monitor the temperature and pressure within a duct, respectively. The pressure within a duct is monitored using a static pressure probe 5 and a differential pressure switch 3 that is interconnected with a single pole micro switch 15, while the temperature is measured using a temperature probe 4 that senses temperature using an RTD 20. The RTD 20 is attached to the end of the temperature probe 4. After installation of the present invention to a duct, the RTD 20 should be residing within the duct. The static pressure probe 5 is a hollow tube that traverses through the static pressure probe hole 12 on the differential pressure housing 2 into the duct. Similarly, a portion of the static pressure probe 5 should reside within the duct after the installation of the present invention.

Within the differential pressure switch housing 2 is a pressure switch diaphragm 16 that is used to determine the instance that the pressure within the duct exceeds a prescribed level. Static pressure within the duct is monitored through a series of processes, beginning with the static pressure probe 5. The concentric hollow tubing of the static pressure probe 5 should cause the internal pressure within a portion of the differential pressure switch housing 2 to become equal to the static pressure within the duct. The pressure switch diaphragm 16 is housed within the differential pressure switch housing 2, in which the pressure switch diaphragm 17 should separate the differential pressure switch housing 2 into two sections. Also, the pressure switch diaphragm 16 should be positioned perpendicularly to the static pressure probe 5 so that an unbalance of pressure within the differential pressure switch housing should result in a linear displacement of the pressure switch diaphragm 16. A pressure relief opening 14 should be positioned on the differential pressure switch housing 2 such that the pressure outside of the differential pressure switch housing 2 is equal to the pressure within the separated section within the differential pressure switch housing 2 that is opposite of the static pressure probe 5. The pressure against the pressure switch diaphragm 16, opposite to the static pressure probe 5, should be equal to the atmospheric pressure. If the atmospheric pressure is equal to the static pressure within the duct, the pressure switch diaphragm 16 should not translate within the differential pressure switch housing 2. This is because there is a balance of pressure against the pressure switch diaphragm 16. If the atmospheric pressure is greater than the static pressure within the duct, the pressure switch diaphragm 16 should translate within the differential pressure switch housing 2 towards the static pressure probe 5. If the static pressure within the duct is greater than the atmospheric pressure, then the pressure switch diaphragm 16 should translate within the differential pressure switch housing 2 away from the static pressure probe 5.

The aforementioned process that causes the pressure switch diaphragm 16 to translate within the differential pressure switch housing 2 should be able to determine the instance the static pressure within the duct has exceeded a prescribed level. A calibration hole 13 should be positioned on the differential pressure switch housing 2, opposite to the static pressure probe 5. This hole should allow an adjustment screw 17 to traverse into the differential pressure switch housing 2. A calibration spring 18 is attached to the pressure switch diaphragm 16 and the adjustment screw 17, concentrically about the calibration hole 13, such that the adjustment screw 17 traverses into the calibration spring 18. This spring should be used to calibrate the prescribed pressure level. In order to calibrate the prescribed pressure level, the adjustment screw 17 must be traversed further into or out of the differential pressure switch housing 2. If it is desired to increase the prescribed pressure level, the adjustment screw 17 should be traversed further into the differential pressure switch housing 2. However, if it is desired to decrease the prescribed pressure level, then the adjustment screw 17 should be traversed further out of the differential pressure switch housing 2. The position of the calibration spring 18 should be a function of the location of the adjustment screw 17. The calibration process is assumed to be the process in which the maximum desired pressure level is set by location of the adjustment screw 17.

The calibration process determines what the maximum static pressure within the duct should be. The purpose of the differential pressure switch 3 should be to send a signal to the controller if the static pressure within duct has exceeded the maximum static pressure set by the adjustment screw 17. The electronic signal being sent to the controller is initiated by a single pole micro switch 15. Such a single pole micro switch 15 allows an electronic signal to be outputted if its circuit becomes closed—the circuit remains open unless it is mechanically closed. The single pole micro switch 15 is electrically connected to a micro switch terminal 23 through a plurality of wires 22. The micro switch terminal 23 should be positioned on a terminal block 8; also a temperature probe terminal 24 should be positioned on the terminal block 8. The terminal block 8 should receive any inputted electrical signals and should have the ability to output the electrical signal to a controller or to a control system. The single pole micro switch 15 should be attached to the differential pressure switch housing 2, in which the single pole micro switch 15 is mechanically connected to the pressure switch diaphragm 16 by a diaphragm connection 19. This diaphragm connection 19 should follow the motion of the pressure switch diaphragm 16 as it translates within the differential pressure switch housing 2. It should be the diaphragm connection 19 that has the ability to cause the circuit of the single pole micro switch 15 to become closed. If the static pressure within the duct becomes greater than the atmospheric pressure, then the motion of the pressure switch diaphragm 16 away from the static pressure probe 5 should cause the diaphragm connection 19 to move towards the single pole micro switch 15. The instance the static pressure within the duct becomes equal to or greater than the prescribed pressure level set by the adjustment screw 17, the diaphragm connection 19 should close the circuit of the single pole micro switch 15. An electronic signal should then be sent from the single pole micro switch 15 to the terminal block 8 and then to the controller or the control system. Conversely, the circuit of the single pole micro switch 15 should not become closed if the static pressure within the duct does not exceed the prescribed pressure level. An electrical signal is also sent from the RTD 20 on the temperature probe 4 to the terminal block 8 independently of the differential pressure switch. The RTD 20 is electrically connected to the temperature probe terminal 24 through a plurality of wires 22. The temperature probe 4 comprises a wire opening 21 that such plurality of wires 22 traverse in order to make its electrical connection with the RTD 20.

The differential pressure switch housing 2 should be located within the sensor housing 1; this is shown in FIG. 1. FIG. 2 also shows the differential pressure switch housing 2 within the sensor housing 1; however, the differential pressure switch housing 2 is shown in broken lines without the entirety of its corresponding components. The sensor housing 1 serves as the outer embodiment of the present invention, containing the pressure and temperature sensing equipment. Although, each the temperature probe 4 and the static pressure probe 5 should traverse out from the sensor housing 1 into a duct when the present invention is installed to a duct. The sensor housing 1 comprises a plurality of mounting brackets 9, a sensor housing opening 10 and a pressure reference opening 11. The pressure reference opening 11 should be positioned adjacent to the sensor housing opening 10. The sensor housing opening 10 provides a space that the static pressure probe 5 and the temperature probe 4 can traverse outwards from the sensor housing 1. Upon installation of the present invention to a duct, the sensor housing opening 10 should be positioned above the duct. The pressure reference opening 11 should be positioned adjacent to the sensor housing opening 10 in order to allow the pressure within the sensor housing 1 to be equal to the atmospheric pressure with minimal variance. A plurality of mounting brackets 9 should be affixed to the sensor housing 1, adjacent to the sensor housing opening 10. These mounting brackets 9 can then be positioned tangent to the embodiment of the duct, in which the plurality of mounting brackets 9 can become affixed to the embodiment of the duct. The plurality of mounting brackets 9 should be affixed to the duct during the installation process using mounting screws or similar existing or future technology.

The object of the present invention is to simultaneously monitor the pressure within a duct and measure the temperature within the same duct, as aforementioned; concurrently, the static pressure probe 5 is positioned near the temperature probe 4 to achieve this. An example of this arrangement is shown in FIG. 1 and FIG. 2. A connector fitting 6 attaches together each the static pressure probe 5 and the temperature probe 4. Unequal pressure distributions occur within a duct while the fan is operating. The connector fitting 6 allows the temperature probe 4 and the static pressure probe 5 to remain rigid during the fan operation. The connector fitting 6 is also connected to the sensor housing 1. The connection to the sensor housing 1 should ensure that both the static pressure probe 5 and the temperature probe 4 remain fixed in their position in accordance with the sensor housing 1 and the duct embodiment. A seal 7 is used to provide an air-tight seal between the sensor housing and the air duct and to prevent a pressure drop within the duct at the location of the static pressure probe 5 and the temperature probe 4. A pressure drop could cause inaccurate responses from the temperature probe 4 or the pressure switch diaphragm; likewise, the fluid motion through the duct could be disturbed undesirably. The preferred embodiment of the seal 7 is a closed cell foam seal, a rubber (neoprene) seal or any similar existing or future technology. The seal 7 is positioned concentrically about the sensor housing opening 10 and is attached to the sensor housing 1, opposite to the connector fitting 6. Also, the seal 7 is traversed by each the static pressure probe 5 and the temperature probe 4. This seal 7 provides an airtight connection between the sensor housing 1 and the duct upon installation. The seal 7 should be located outside of the sensor housing's 1 embodiment. During installation of the mounting brackets 9 to the duct, the seal 7 should be compressed against the embodiment of the duct. Ultimately, the seal 7 should provide a blockage of air from the sensor housing opening 10 to the locations on the duct that the static pressure probe 5 and the temperature probe 4 traverses through. The embodiment of the seal 7 should contour to the embodiment of each the sensor housing 1 and the duct embodiment. Also, the terminal block 8 should remain rigid because it adhered to the sensor housing 1. It is assumed that the plurality of wires 22 that the present invention comprises do not interfere with any mechanical connections made by its components.

The aforementioned pressure switch could also be substituted with an analog pressure transmitter. The analog pressure transmitter could allow the present invention to monitor actual HVAC duct static pressure. This could be used for HVAC fan status and for such common control functions as fan speed control and air filter monitoring. An electrical connection should be made with the micro switch terminal 23 in such a configuration instead of the single pole micro switch 15. This allows the electrical signal from the analog pressure transmitter to be delivered to the control system to analyze the actual duct static pressure. The RTD 20 could also be configured within the static pressure probe 5 such that it is not attached a temperature probe 4. Therefore, the temperature probe 4 could be eliminated from the present invention for it would not be needed. However, the RTD 20 should remain electrically connected to the temperature probe terminal 24 through a plurality of wires 22. Such alternative configurations should allow the present invention to function similarly as a combination pressure and temperature sensor for simultaneous temperature and pressure analyzing in HVAC ducts.

Although the invention has been explained in relation to its preferred embodiment, it is to be understood that many other possible modifications and variations can be made without departing from the spirit and scope of the invention as hereinafter claimed.

What is claimed is:

1. A dual temperature sensor and pressure switch comprises,
a sensor housing;
a differential pressure switch housing;
a differential pressure switch;
a temperature probe;
a static pressure probe;
a connector fitting;
a seal;
a terminal block;
the sensor housing comprises a plurality of mounting brackets, a sensor housing opening and a pressure reference opening;
the differential pressure switch housing comprises a static pressure probe hole, a calibration hole and a pressure relief opening;
the differential pressure switch comprises a single pole micro switch, a pressure switch diaphragm, an adjustment screw, a calibration spring and a diaphragm connection;
the temperature probe comprises an RTD and a wire opening; and
the terminal block comprises a plurality of wires, a micro switch terminal and a temperature probe terminal.

2. The dual temperature sensor and pressure switch as claimed in claim 1 comprises,
the pressure reference opening being positioned adjacent to the sensor housing opening;
the seal being positioned concentrically about the sensor housing opening;
the differential pressure switch housing being located within the sensor housing;
the pressure relief opening being positioned above the pressure reference opening;
the temperature probe traversing the connector fitting, the seal and the sensor housing opening; and
the static pressure probe traversing the probe hole, the connector fitting, the seal and the sensor housing opening.

3. The dual temperature sensor and pressure switch as claimed in claim 2 comprises,
the plurality of mounting tabs being affixed to the sensor housing, adjacent to the sensor housing opening;
the static pressure probe being affixed to the differential pressure switch housing;
the pressure relief opening being positioned adjacent to the static pressure probe hole;
the seal being attached to the sensor housing;
the connector fitting being connected to the sensor housing, opposite to the seal; and
the connector fitting being attached to each the temperature probe and the static temperature probe.

4. The dual temperature sensor and pressure switch as claimed in claim 1 comprises,
the pressure switch diaphragm being housed by the differential pressure switch housing;
the calibration spring being attached to the pressure switch diaphragm;
the calibration spring being traversed by the adjustment screw; and
the diaphragm connection being attached to each the pressure switch diaphragm and the single pole micro switch.

5. The dual temperature sensor and pressure switch as claimed in claim 4 comprises,
the pressure switch diaphragm being oriented perpendicularly to the static pressure probe;
the calibration hole being traversed by the adjustment screw; and
the micro switch being affixed to the differential pressure switch housing, opposite to the calibration spring.

6. The dual temperature sensor and pressure switch as claimed in claim 1 comprises,
the single pole micro switch being electrically connected to the micro switch terminal by a plurality of wires;
the RTD being electrically connected to the temperature probe terminal by a plurality of wires, wherein the wire opening is traversed by the plurality of wires; and
the RTD being attached to the temperature probe, opposite to the wire opening.

7. The dual temperature sensor and pressure switch as claimed in claim 6 comprises,
the terminal block being adhered to the sensor housing; and
the terminal block being located within the sensor housing.

8. A dual temperature sensor and pressure switch comprises,
a sensor housing;
a differential pressure switch housing;
a differential pressure switch;
a temperature probe;
a static pressure probe;
a connector fitting;
a seal;
a terminal block;
the sensor housing comprises a plurality of a pressure reference opening;
the differential pressure switch housing comprises a pressure relief opening;
the differential pressure switch comprises a single pole micro switch, a pressure switch diaphragm, an adjustment screw, a calibration spring;
the temperature probe comprises an RTD; and
the terminal block comprises a plurality of wires and a plurality of terminals.

9. The dual temperature sensor and pressure switch as claimed in claim 8 comprises,
the differential pressure switch housing being housed within the sensor housing;
the static pressure probe traversing the differential pressure switch housing, the connector fitting, the sensor housing and the seal;
the pressure relief opening being positioned opposite to the static pressure probe;
the temperature probe traversing the sensor housing;
the static pressure probe being affixed to the differential pressure switch housing;
the seal being attached to the sensor housing;
the connector fitting being affixed to each the static pressure probe and the temperature probe;
the connector fitting being affixed to the sensor housing and the seal; and
the RTD being attached to the temperature probe.

10. The dual temperature sensor and pressure switch as claimed in claim 8 comprises,
the pressure switch diaphragm being housed by the differential pressure switch housing;
the calibration spring being attached to each the pressure switch diaphragm and the adjustment screw;
the adjustment screw traversing each the differential pressure switch housing and the calibration spring;
the pressure switch diaphragm being attached to the single pole micro switch; and
the pressure reference opening being positioned adjacent to the static pressure probe.

11. The dual temperature sensor and pressure switch as claimed in claim 10 comprises,
the pressure switch diaphragm being positioned perpendicularly to the static pressure probe; and
the single pole micro switch being affixed to the differential pressure switch housing.

12. The dual temperature sensor and pressure switch as claimed in claim 8 comprises,
the single pole micro switch being electrically connected to a terminal through a plurality of wires; and
the RTD being electrically connected to a terminal through a plurality of wires.

13. The dual temperature sensor and pressure switch as claimed in claim 12 the terminal block being adhered to the sensor housing.

14. A dual temperature sensor and pressure switch comprises,
a differential pressure switch housing;
a differential pressure switch;
a static pressure probe;
a connector fitting;
a seal;
a terminal block;
an RTD
the differential pressure switch housing comprises a pressure relief opening;
the differential pressure switch comprises a single pole micro switch, a pressure switch diaphragm, an adjustment screw, a calibration spring; and
the terminal block comprises a plurality of wires and a plurality of terminals.

15. A dual temperature sensor and pressure switch as claimed in claim 14 comprises,
the pressure switch diaphragm being housed by the differential pressure switch housing;
the static pressure probe traversing the differential pressure switch housing, the connector fitting and the seal;
the RTD being housed by the static pressure probe;
the static pressure probe being affixed to the differential pressure switch housing;
the seal being attached to the differential pressure switch housing;
the connector fitting being affixed to the static pressure probe; and
the connector fitting being affixed to the differential pressure switch housing and the seal.

16. The dual temperature sensor and pressure switch as claimed in claim 15 comprises,
the calibration spring being attached to each the pressure switch diaphragm and the adjustment screw;
the adjustment screw traversing each the differential pressure switch housing and the calibration spring; and
the pressure switch diaphragm being attached to the single pole micro switch.

17. The dual temperature sensor and pressure switch as claimed in claim 14 comprises,
the pressure switch diaphragm being positioned perpendicularly to the static pressure probe; and
the single pole micro switch being adhered to the differential pressure switch housing.

18. The dual temperature sensor and pressure switch as claimed in claim 14 comprises,
the single pole micro switch being electrically connected to a terminal through a plurality of wires; and
the RTD being electrically connected to a terminal through a plurality of wires.

19. The dual temperature sensor and pressure switch as claimed in claim 18 comprises,
the terminal block being adhered to the sensor housing.
